(19) United States
(12) Patent Application Publication
(10) Pub. No.: US 2024/0314261 A1
(43) Pub. Date: Sep. 19, 2024

(54) METHOD FOR SPECIAL EFFECT RENDERING, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Yucheng WEI, Beijing (CN); Qiang ZHAO, Beijing (CN); Jiannan LI, Beijing (CN); Jian WANG, Beijing (CN); Wansi LIU, Beijing (CN); Yaqing LI, Beijing (CN)

(21) Appl. No.: 18/461,885

(22) Filed: Sep. 6, 2023

(30) Foreign Application Priority Data
Mar. 13, 2023 (CN) 202310238963.4

(51) Int. Cl. H04N 5/262; H04N 5/272

(52) U.S. Cl. CPC H04N 5/2621; H04N 5/272

(57) ABSTRACT

The present disclosure discloses a method for special effect rendering, an electronic device and a storage medium. The method includes: acquiring foreground special effect data corresponding to a special effect rendering instruction, background special effect data corresponding to the special effect rendering instruction and a real-time live video stream of a target live streaming room in response to receiving the special effect rendering instruction for the target live streaming room; obtaining merging special effect data by performing special effect fusion on the real-time live video stream based background special effect data; and displaying a first live page corresponding to the target live streaming room by performing parallel rendering on the merging special effect data and the foreground special effect data.

### CROSS-REFERENCE TO RELATED APPLICATION

This application claims priority to Chinese Patent Application No. 202310238963.4, filed on Mar. 13, 2023, the entire disclosure of which is incorporated herein by reference.

### TECHNICAL FIELD

The present disclosure relates to a field of Internet technologies, and particularly to a method for special effect rendering, an electronic device and a storage medium.

### BACKGROUND

With the development of Internet technologies, various live streaming functions are widely popularized. For example, an audience terminal of a live streaming room may trigger a special effect rendering in a live streaming process by presenting a virtual resource.

In the related art, special effect rendering solutions of the live streaming process mainly include rendering by stream merging and local rendering. The rendering by stream merging supports a combination of a special effect and a live video stream. However, a layer order of the special effect rendering is bound with the live video stream that is usually at a bottom layer of a live streaming page, thus the special effect may be occluded by a service user interface (UI) such as comment information, resulting in a poor user sensory experience and a poor presentation effect of the special effect. The local rendering separately creates a special effect rendering view in the live streaming room that supports to be placed at any rendering hierarchical position in a live streaming room page. However, through separately creating the special effect rendering view, the special effect can not be combined with the live video stream, resulting in a monotonous special effect and a poor live streaming atmosphere. Therefore, there is a need to provide a more efficient special effect rendering solution.

### SUMMARY

According to a first aspect of embodiments of the present disclosure, a method for special effect rendering is provided. The method is applied to a first terminal and includes:
acquiring foreground special effect data corresponding to a special effect rendering instruction, background special effect data corresponding to the special effect rendering instruction and a real-time live video stream of a target live streaming room in response to receiving the special effect rendering instruction for the target live streaming room;
obtaining merging special effect data by performing special effect fusion on the real-time live video stream based on the background special effect data; and
displaying a first live page corresponding to the target live streaming room by performing parallel rendering on the merging special effect data and the foreground special effect data.

According to a second aspect of embodiments of the present disclosure, a method for special effect rendering is provided. The method is applied to a second terminal and includes:
acquiring merging special effect data of a target live streaming room and foreground special effect data corresponding to a special effect rendering instruction in response to receiving the special effect rendering instruction for the target live streaming room: in which the merging special effect data is obtained by performing special effect fusion on a real-time live video stream of the target live streaming room based on background special effect data corresponding to the special effect rendering instruction; and
displaying a second live page corresponding to the target live streaming room by performing parallel rendering on the merging special effect data and the foreground special effect data.

According to a third aspect of embodiments of the present disclosure, an electronic device is provided, and includes: a processor: a memory configured to store instructions executable by the processor. The processor is configured to:
acquire foreground special effect data corresponding to a special effect rendering instruction, background special effect data corresponding to the special effect rendering instruction and a real-time live video stream of a target live streaming room, in response to receiving the special effect rendering instruction for the target live streaming room;
obtain merging special effect data by performing special effect fusion on the real-time live video stream based on the background special effect data; and
display a first live page corresponding to the target live streaming room by performing parallel rendering on the merging special effect data and the foreground special effect data.

It should be noted that, the details above and in the following are exemplary and illustrative, and do not constitute the limitation on the present disclosure.

### BRIEF DESCRIPTION OF THE DRAWINGS

The drawings herein are incorporated into the specification and constitute a part of the specification, show embodiments in conformity with embodiments of the present disclosure, and explain the principle of the present disclosure together with the specification.

FIG. 1 is a diagram illustrating an application environment according to an embodiment.

FIG. 2 is a flowchart illustrating a method for special effect rendering applicable to a first terminal according to an embodiment.

FIG. 3 is a flowchart illustrating acquiring foreground special effect data corresponding to a special effect rendering instruction, background special effect data corresponding to the special effect rendering instruction and a real-time live video stream of a target live streaming room in response to receiving the special effect rendering instruction for the target live streaming room according to an embodiment.

FIG. 4 is a flowchart illustrating obtaining merging special effect data by performing special effect fusion on a real-time live video stream based on background special effect data according to an embodiment.

FIG. 5 is a diagram illustrating a first live page according to an embodiment.

FIG. 6 is a flowchart illustrating a method for special effect rendering applicable to a second terminal according to an embodiment.

FIG. 7 is a diagram illustrating a second live page according to an embodiment.

FIG. 8 is a flowchart illustrating a method for special effect rendering in a perspective of interaction between a first terminal, a server and a second terminal according to an embodiment.

FIG. 9 is a block diagram illustrating an apparatus for special effect rendering applicable to a first terminal according to an embodiment.

FIG. 10 is a block diagram illustrating an apparatus for special effect rendering applicable to a second terminal according to an embodiment.

FIG. 11 is a block diagram illustrating an electronic device for special effect rendering according to an embodiment.

### DETAILED DESCRIPTION

In order to make those skilled in the art better understand the technical solution of the present disclosure, the technical solution in embodiments of the present disclosure will be described clearly and completely in combination with the appended drawings in embodiments of the present disclosure.

It needs to be noted that, the “first”, “second” or similar words used in the present summary and the appended claims are configured only to distinguish similar objects, rather than describe a specific order or a precedence order. It should be understood that the data used herein may be interchanged where appropriate so that the embodiments of the present disclosure described herein may be implemented in an order other than illustrated or described herein. The implementations described in the following embodiments do not represent all implementations consistent with the present disclosure. Rather, they are merely examples of apparatuses and methods consistent with some aspects of the disclosure as detailed in the appended claims.

It should be noted that user information (including but not limited to user equipment information and user personal information) and data (including but not limited to displayed data and analyzed data) involved in the present disclosure are information and data authorized by a user or fully authorized by each party.

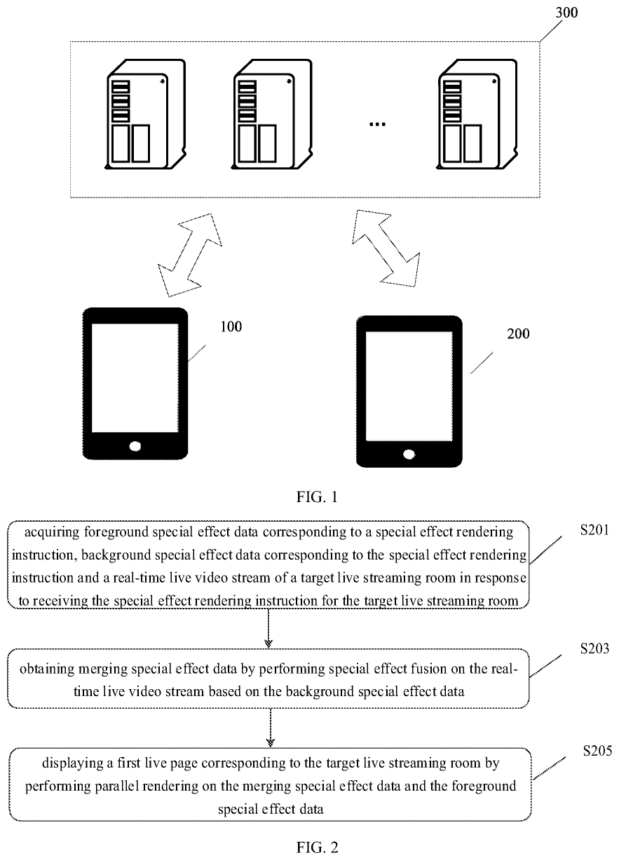

As illustrated in FIG. 1, FIG. 1 is a diagram illustrating an application environment according to an embodiment. The application environment may include a first terminal 100, a second terminal 200 and a server 300.

In an embodiment, the first terminal 100 may be an anchor client: the second 200 may be an audience client; and the server 300 may be a background server of a live streaming platform. In an implementation, the server 300 may provide the first terminal 100 and the second terminal 200 with stream pushing and pulling and interaction services in a live streaming process.

In an embodiment, the first terminal 100 and the second terminal 200 may include but not limited to a smart phone, a desktop computer, a tablet computer, a laptop, a smart speaker, a digital assistant, an augmented reality (AR)/virtual reality (VR) device, a smart wearable device and other types of electronic devices, and may also be a software running on the above electronic devices, such as an application. In an implementation, an operating system running on the electronic device may include but not limited to an Android system, an IOS system, Linux and Windows.

In an embodiment, the server 300 may be an independent physical server or a server cluster or a distributed system consisting of a plurality of physical servers.

In addition, it needs to be noted that, only one application environment provided in the disclosure is illustrated in FIG. 1. In actual applications, other application environments may be further included, and for example, more second terminals may be further included.

In embodiments of the disclosure, the first terminal 100, the second terminal and the server 300 may be directly or indirectly connected in a wired or wireless communication mode, which are not limited in the disclosure.

FIG. 2 is a flowchart illustrating a method for special effect rendering according to an embodiment. As illustrated in FIG. 2, the method is applicable to an electronic device such as a first terminal, and specifically, the method may include the following steps.

At step S201, in response to receiving a special effect rendering instruction for a target live streaming room, foreground special effect data corresponding to the special effect rendering instruction, background special effect data corresponding to the special effect rendering instruction and a real-time live video stream of the target live streaming room are acquired.

In a specific embodiment, the foreground special effect data may be a rendering material corresponding to a part that cannot be occluded in a target special effect corresponding to the special effect rendering instruction: the background special effect data may be a rendering material corresponding to a part of special effects that need to be fused with a real-time live video stream in the target special effect: specifically, the real-time live video stream may be a video stream captured by a camera device on a first terminal side. The target live streaming room may be any live streaming room is a live streaming platform.

In a specific embodiment, a special effect rendering instruction may be triggered in the live streaming room in various manners. For example, a live browsing object in a target live streaming room (an audience account) may trigger a special effect rendering instruction (that is, a special effect rendering instruction for presenting a virtual resource) by executing an operation of presenting the virtual resource to a live streaming initiating object (an anchor account) in the target live streaming room. In an implementation, in response to a certain task in the target live streaming room being completed, a special effect rendering instruction (a special effect rendering instruction prompting that a task is completed) may also be triggered.

In an embodiment, taking the special effect rendering instruction for presenting the virtual resource as an example, a second terminal where a certain live browsing object in the target live streaming room is located may send a special effect rendering instruction (a special effect rendering instruction for presenting the virtual resource) to the server, and in an implementation, when an execution body is a first terminal, receiving the special effect rendering instruction for the target live streaming room may be receiving a special effect rendering instruction sent by the server: in an implementation, the execution body may also be a second terminal where an audience account triggering the special effect rendering instruction is located, and correspondingly, receiving the special effect rendering instruction for the target live streaming room may detect a locally triggered special effect rendering instruction for the target live streaming room.

In an embodiment, an anchor may select whether to enable matching the special effect rendering with presenting the virtual resource in combination with actual requirements: in an implementation, when the anchor enables matching the special effect rendering with presenting the virtual resource, an audience account in the live streaming room may trigger the special effect rendering instruction by executing an operation of presenting the virtual resource, and otherwise, when the anchor disenables matching the special effect rendering with presenting the virtual resource, the audience account in the live streaming room may executes the operation of presenting the virtual resource without triggering the special effect rendering instruction.

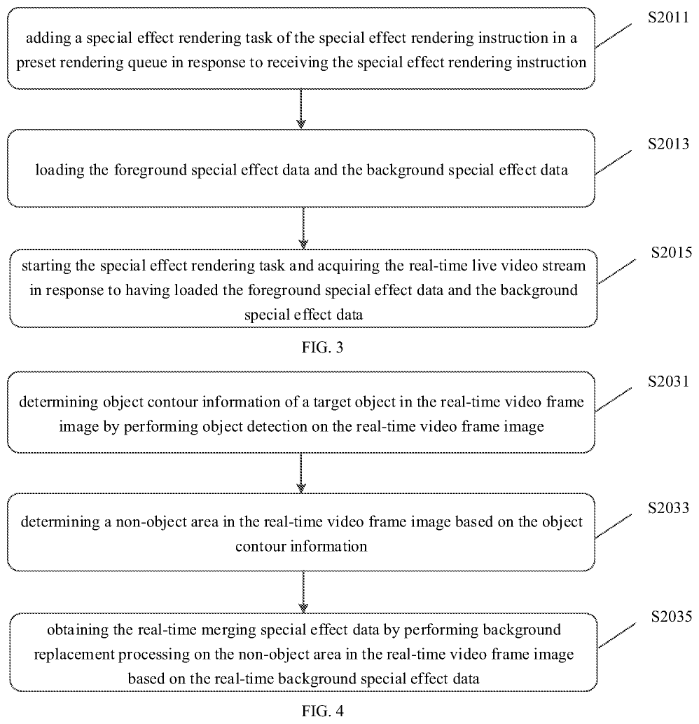

In a specific embodiment, as illustrated in FIG. 3, acquiring foreground special effect data corresponding to a special effect rendering instruction, background special effect data corresponding to the special effect rendering instruction and a real-time live video stream of a target live streaming room in response to receiving the special effect rendering instruction for the target live streaming room includes the following steps.

At step S2011, a special effect rendering task of the special effect rendering instruction is added in a preset rendering queue in response to receiving the special effect rendering instruction:
at step S2013, the foreground special effect data and the background special effect data are loaded;
at step S2015, the special effect rendering task is started and the real-time live video stream is acquired in response to having loaded the foreground special effect data and the background special effect data.

In a specific embodiment, the preset rendering queue may be a queue for storing a special effect rendering task to be processed: in practical applications, the foreground special effect data and the background special effect data need to be loaded from the server; and correspondingly, in response to receiving the special effect rendering instruction, a special effect rendering task of the special effect rendering instruction is added in the preset rendering queue to queue the special effect rendering, and in response to having loaded the foreground special effect data and the background special effect data, the special effect rendering task is started (correspondingly, the special effect rendering task is out of queue) and a real-time live video stream is acquired, to display a live page rendering with a special effect.

In the above embodiment, a special effect rendering task of the special effect rendering instruction is added in the preset rendering queue first in response to receiving the special effect rendering instruction, which can achieve management of the special effect rendering task to be processed, and in response to having loaded the foreground special effect data and the background special effect data, the special effect rendering task is started and the real-time live video stream is acquired, which can ensure synchronous rendering of the foreground special effect data and the background special effect data on the basis of layered rendering of the foreground special effect data and the background special effect data.

At step S203, merging special effect data is obtained by performing special effect fusion on the real-time live video stream based on the background special effect data.

In a specific embodiment, the merging special effect data may be the real-time live video stream fused with the background special effect data.

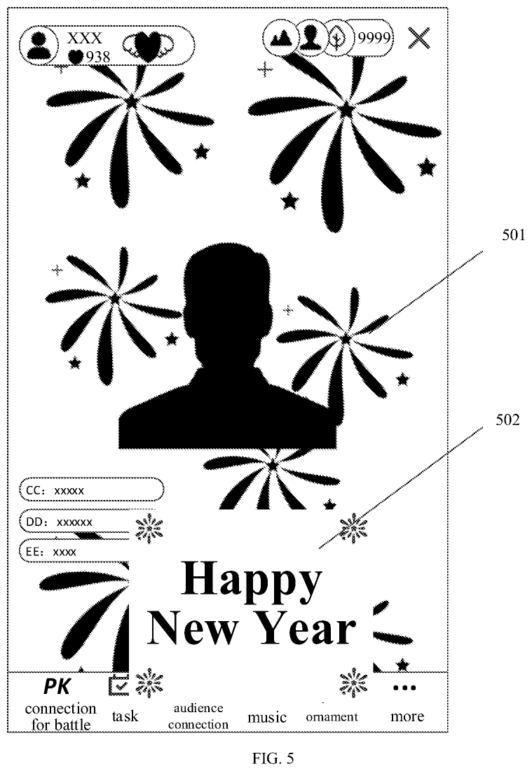

In actual applications, a special effect is dynamic, and may correspond to a plurality of frames of live video images (that is, a plurality of real-time video frame images), and correspondingly, the background special effect data includes real-time background special effect data respectively corresponding to the plurality of real-time video frame images: the foreground special effect data includes real-time foreground special effect data respectively corresponding to the plurality of real-time video frames. Specifically, the plurality of real-time video frames are a plurality of frames of consecutive live video images in the target live streaming room: correspondingly, a special effect fusion can be performed on each frame of live video image in combination with the background special effect data corresponding to each frame of the live video image. In an implementation, for any one of the plurality of real-time live video stream images, the real-time live video stream may include the real-time video frame image (that is, a frame of live video image), and the background special effect data includes real-time background special effect data corresponding to the real-time video frame image, the merging special effect data includes real-time merging special effect data corresponding to the real-time video frame image. In an implementation, as illustrated in FIG. 4, obtaining the merging special effect data by performing special effect fusion on the real-time live video stream based on the background special effect data includes following steps.

At step S2031, object contour information of a target object in the real-time video frame image is determined by performing object detection on the real-time video frame image:
at step S2033, a non-object area in the real-time video frame image is determined based on the object contour information; and
at step S2035, the real-time merging special effect data is obtained by performing background replacement processing on the non-object area in the real-time video frame image based on the real-time background special effect data.

In a specific embodiment, the target object may be an image of an area where an anchor is located in the real-time video frame image, and may obtain object contour information of the target object in the real-time video frame image by performing object detection by inputting the real-time video frame image into an object detection network: specifically, the object detection network may be a pre-trained deep learning network for detecting an object. Specifically, the non-object area in the real-time video frame image may be an area other than the area where the anchor is located in the real-time video frame image.

In the above embodiment, the non-object area in the real-time video frame image can be accurately positioned based on the object contour information determined by performing object detection on the real-time video frame image, and further a background replacement processing can be performed on the non-object area in the real-time video frame image based on the real-time background special effect data, which achieves fusion of the background special effect data and the live video stream, enriches a special effect effort, and enhances a live streaming atmosphere.

In addition, it should be noted that in practical applications, a special effect fusion of the background special effect data and the real-time live video stream is not limited to the above special effect fusion mode of replacing the background of the anchor, and may further include special effect fusions such as adding a 3D head ornament of the anchor, face deformation and deformation of an image in a specific area, and specifically, a special effect fusion of the background special effect data and the real-time live video stream can be achieved in combination with corresponding artificial intelligence algorithms. For example, the special effect fusion of adding the 3D head ornament to the anchor may be combined with a head detection network (an artificial intelligence algorithm) to detect an area where an anchor head is located in the real-time video frame image, and a special effect fusion is performed over the area where the anchor head is located in the real-time video frame image in combination with the special effect data corresponding to the 3D head ornament (background special effect data).

At step S205, a first live page corresponding to the target live streaming room is displayed by performing parallel rendering on the merging special effect data and the foreground special effect data.

In a specific embodiment, a rendering layer corresponding to the merging special effect data is located at the lowest layer of the first live page, and the foreground special effect data is located at the top layer of the first live page. In an embodiment, a service user interface (UI) (such as comment information) is often displayed in the live page, and in an implementation, the rendering layer corresponding to the service UI may be located at a layer higher than the rendering layer corresponding to the merging special effect data, and a layer lower than the rendering layer corresponding to the foreground special effect data.

In an embodiment, in response to obtaining the merging special effect data and the foreground special effect data corresponding to one frame of live video image, a live page corresponding to the frame of live video image may be rendered, and in an implementation, the real-time live video stream may include a real-time video frame image, and the foreground special effect data includes real-time foreground special effect data corresponding to the real-time video frame image: the merging special effect data includes real-time merging special effect data corresponding to the real-time video frame image, and a parallel rendering can be performed on the real-time foreground special effect data corresponding to the real-time video frame image and the real-time merging special effect data corresponding to the real-time video frame image; and correspondingly, displaying the first live page corresponding to the target live streaming room by performing parallel rendering on the merging special effect data and the foreground special effect data may include:
displaying the first live page by performing parallel rendering on the real-time merging special effect data and the real-time foreground special effect data.

In an embodiment, the first live page may be a live page of an anchor client in the target live streaming room in response to an execution body being a first terminal. The first live page may be a live page of an audience client triggering a special effect rendering instruction in the target live streaming room in response to the execution body being a second terminal.

In the above embodiment, the parallel rendering is performed on the real-time merging special effect data and the real-time foreground special effect data, which can ensure synchronous rendering of the foreground special effect and the background special effect on the basis of effectively avoiding that the foreground special effect is occluded, which greatly improves a user sensory experience and a special effect presentation effect, and the background special effect data is fused into the real-time live video stream, which can enrich a special effect effort and enhance a live streaming atmosphere.

In a specific embodiment, taking a live page of the anchor client for example, as illustrated in FIG. 5. FIG. 5 is a diagram illustrating a first live page according to an embodiment. Specifically, a target special effect corresponding to the special effect rendering instruction is a fireworks special effect with a theme of “Happy New Year”; and the target special effect includes a background special effect at the same layer as the live video stream (a background fireworks special effect 501 at the same layer as an anchor in FIG. 5) and a foreground special effect at the top layer (a foreground special effect 502 consisting of the “Happy New Year” and the fireworks in FIG. 5).

According to the technical solution provided in embodiments of the disclosure, in response to receiving the special effect rendering instruction for the target live streaming room, the foreground special effect data corresponding to the special effect rendering instruction, the background special effect data corresponding to the special effect rendering instruction and the real-time live video stream of the target live streaming room are acquired, so that special effect data to be rendered can be divided into foreground special effect data and background special effect data, and a special effect fusion can be performed on the background special effect data and the real-time live video stream, which can enrich a special effect effort and enhance a live streaming atmosphere and avoid the special effect being occluded, and a parallel rendering can be performed on the live video stream fused with the background special effect data (that is, merging special effect data) and the foreground special effect data, which can ensure a synchronous rendering of a foreground special effect and a background special effect, and greatly improve a user sensory experience and a special effect presentation effect.

In an embodiment, the method may further include:
synchronously pushing the merging special effect data and the foreground special effect data to a live browsing object in the target live streaming room.

In a specific embodiment, the merging special effect data and the foreground special effect data may be synchronously sent to a server, and synchronously pushed by the server to a live browsing object in the target live streaming room (an audience account in the live streaming room).

In the above embodiment, when a stream is pushed, the merging special effect data (the real-time live video stream fused with the background special effect data) is directly pushed, and corresponding foreground special effect data is synchronously pushed to ensure a frame alignment between the merging special effect data and the foreground special effect data on an audience client side, and the audience client does not need to perform fusion on the background special effect data and the real-time live video stream, which may effectively reduce performance requirements for the device at the audience client, and improve a user coverage rate of a special effect rendering function.

In an embodiment, the method may further include:
obtaining a target video coding file by writing the foreground special effect data into a live video coding file in response to performing parallel rendering on the merging special effect data and the foreground special effect data.

In actual applications, the video coding processing is usually performed on the video stream to obtain the corresponding video coding file before transmission and then the video coding file is transmitted. In an implementation, foreground special effect data corresponding to background special effect data fused in the merging special effect data may be written into a corresponding video coding file, to ensure a frame alignment between the foreground special effect data and the merging special effect data (the background special effect data and the background special effect data).

In a specific embodiment, the live video coding file is a video coding file corresponding to the merging special effect data; and the target video coding file may be a live video coding file added with corresponding foreground special effect data.

Correspondingly, synchronously pushing the merging special effect data and the foreground special effect data to the live browsing object in the target live streaming room may include:
pushing the target video coding file to the live browsing object.

Specifically, the target video coding file may be pushed to a server, and pushed by the server to a live browsing object (that is, sent to a terminal where the live browsing object in the target live streaming room is located).

In the above embodiment, the live video coding file added with the corresponding foreground special effect data is synchronously pushed, which can ensure a frame alignment between the merging special effect data and the foreground special effect data on the audience client side, and the audience client does not need to perform fusion on the background special effect data and the real-time live video stream, which may effectively reduce performance requirements for the device at the audience client, and improve a user coverage rate of a special effect rendering function . . . .

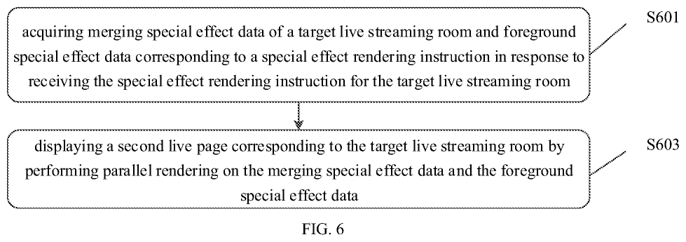

FIG. 6 is a flowchart illustrating a method for special effect rendering according to an embodiment. As illustrated in FIG. 6, the method is applicable to an electronic device such as a second terminal, and specifically, the method may include the following steps.

At step S601, merging special effect data of a target live streaming room and foreground special effect data corresponding to a special effect rendering instruction are acquired in response to receiving the special effect rendering instruction for the target live streaming room.

In a specific embodiment, the merging special effect data may be obtained by performing special effect fusion on a real-time live video stream of the target live streaming room based on background special effect data corresponding to the special effect rendering instruction.

In an embodiment, acquiring the merging special effect data of the target live streaming room and the foreground special effect data corresponding to the special effect rendering instruction may include:
synchronously pulling the merging special effect data and the foreground special effect data from a server.

In an embodiment, synchronously pulling the merging special effect data and the foreground special effect data from the server includes:
pulling a target video coding file from the server, in which the target video coding file is a live video coding file into which the foreground special effect data is written, and the live video coding file is a video coding file corresponding to the merging special effect data; and
obtaining the merging special effect data and the foreground special effect data by parsing the target video coding file.

In a specific embodiment, the live video coding file and the foreground special effect data may be parsed from the target video coding file first, and the live video coding file may be decoded to obtain the merging special effect data.

In the above embodiment, when a stream is pulled, a live video coding file added with the corresponding foreground special effect data is directly obtained, and the live video coding file is a video coding file corresponding to the merging special effect data, which can ensure a frame alignment between the merging special effect data and the foreground special effect data on the audience client side, and the audience client does not need to perform fusion on the background special effect data and the real-time live video stream, which can effectively reduce performance requirements for the device at the audience client, and improve a user coverage rate of a special effect rendering function.

At step S603, a second live page corresponding to the target live streaming room is displayed by performing parallel rendering on the merging special effect data and the foreground special effect data.

In a specific embodiment, the second live page may be a live page of any audience client in the target live streaming room. In a specific embodiment, a rendering layer corresponding to the merging special effect data is located at the lowest layer of the second live page; and the foreground special effect data is located at the top layer of the second live page. In an embodiment, a service user interface (UI) (such as comment information) is often displayed in the live page, and in an implementation, the rendering layer corresponding to the service UI may be located at a layer higher than the rendering level corresponding to the merging special effect data, and a layer lower than the rendering level corresponding to the foreground special effect data.

In an embodiment, in response to obtaining the merging special effect data and the foreground special effect data corresponding to one frame of live video image (a live video frame image), a live page corresponding to the frame of live video image may be rendered, and in an implementation, the real-time live video stream may include a real-time video frame image, and the merging special effect data includes real-time merging special effect data corresponding to the real-time video frame image; and the foreground special effect data includes real-time foreground special effect data; and correspondingly, displaying the second live page corresponding to the target live streaming room by performing parallel rendering on the merging special effect data and the foreground special effect data may include:
displaying the second live page by performing parallel rendering on the real-time merging special effect data and the real-time foreground special effect data.

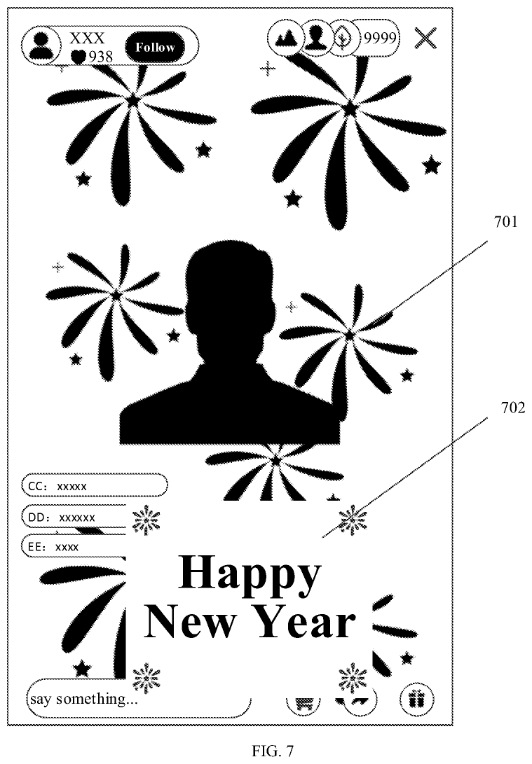

In a specific embodiment, as illustrated in FIG. 7, FIG. 7 is a diagram illustrating a second live page according to an embodiment. Specifically, a target special effect corresponding to the special effect rendering instruction is a fireworks special effect with a theme of “Happy New Year”; and the target special effect includes a background special effect at the same layer as the live video stream (a background fireworks special effect 701 at the same layer as an anchor in FIG. 7) and a foreground special effect at the top layer (a foreground special effect 702 consisting of the “Happy New Year” and the fireworks in FIG. 7).

In the above embodiment, the parallel rendering is performed on the real-time merging special effect data and the real-time foreground special effect data, which can ensure synchronous rendering of the foreground special effect and the background special effect on the basis of effectively avoiding that the foreground special effect is occluded, which greatly improves a user sensory experience and a special effect presentation effect, and the background special effect data is fused into the real-time live video stream, which can enrich a special effect effort and enhance a live streaming atmosphere.

According to the technical solution provided in embodiments of the disclosure, the merging special effect data of the target live streaming room and the foreground special effect data corresponding to the special effect rendering instruction are acquired in response to receiving the special effect rendering instruction for the target live streaming room: the merging special effect data is obtained by performing special effect fusion on the real-time live video stream of the target live streaming room based on the background special effect data corresponding to the special effect rendering instruction, so that special effect data to be rendered can be divided into foreground special effect data and background special effect data, and a special effect fusion can be performed on the background special effect data and the real-time live video stream, which can enrich a special effect effort and enhance a live streaming atmosphere and avoid the special effect being occluded, and a parallel rendering may be performed on the live video stream fused with the background special effect data (that is, merging special effect data) and the foreground special effect data, which can ensure a synchronous rendering of a foreground special effect and a background special effect, and greatly improve a user sensory experience and a special effect presentation effect.

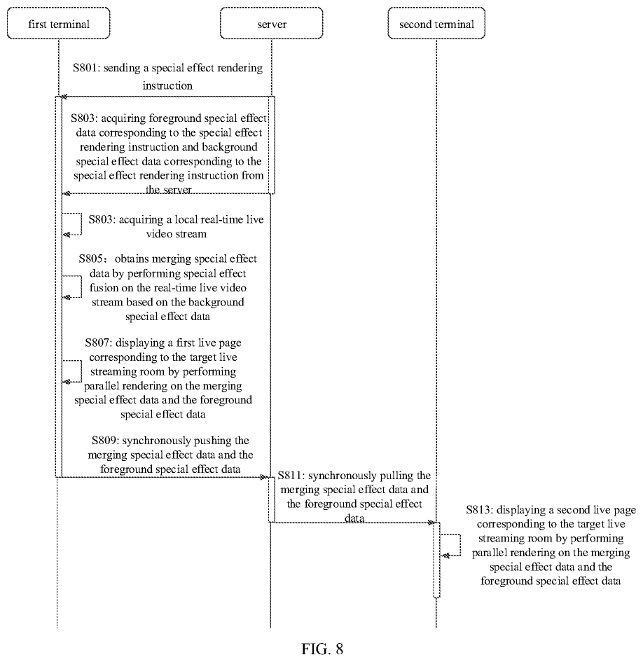

In a specific embodiment, a method for special effect rendering according to embodiments of the disclosure is introduced in a perspective of interaction between the first terminal, the server and the second terminal. As illustrated in FIG. 8, FIG. 8 is a flowchart illustrating a method for special effect rendering according to an embodiment. Specifically, it may include the following steps:
at step S801, the server sends a special effect rendering instruction to the first terminal;
at step S802, the first terminal acquires foreground special effect data corresponding to the special effect rendering instruction and background special effect data corresponding to the special effect rendering instruction from the server and the first terminal acquires a local real-time live video stream;
at step S805, the first terminal obtains merging special effect data by performing special effect fusion on the real-time live video stream based on the background special effect data;
at step S807, the first terminal displays a first live page corresponding to the target live streaming room by performing parallel rendering on the merging special effect data and the foreground special effect data;
at step S809, the first terminal synchronously pushes the merging special effect data and the foreground special effect data to the server;
at step S811, the second terminal synchronously pulls the merging special effect data and the foreground special effect data from the server;
at step S813, the second terminal displays a second live page corresponding to the target live streaming room by performing parallel rendering on the merging special effect data and the foreground special effect data.

With regard to the method in the above embodiments, the specific implementation in which each step performs the operation has been described in embodiments of the method, which will not be elaborated here.

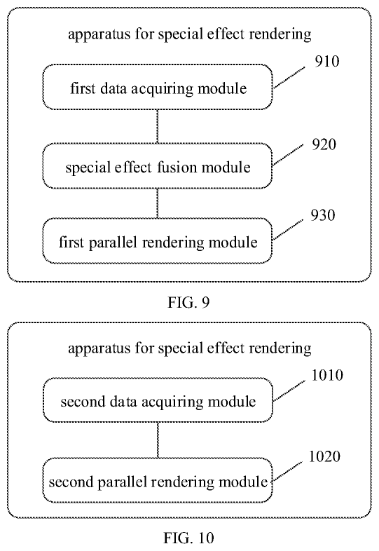

FIG. 9 is a block diagram illustrating an apparatus for special effect rendering applicable to a first terminal according to an embodiment. As illustrated in FIG. 9, the apparatus includes a first data acquiring module 910, a special effect fusion module 920 and a first parallel rendering module 930.

The first data acquiring module 910 is configured to perform acquiring foreground special effect data corresponding to a special effect rendering instruction, background special effect data corresponding to the special effect rendering instruction and a real-time live video stream of a target live streaming room in response to receiving the special effect rendering instruction for the target live streaming room.

The special effect fusion module 920 is configured to perform obtaining merging special effect data by performing special effect fusion on the real-time live video stream based background special effect data.

The first parallel rendering module 930 is configured to perform displaying a first live page corresponding to the target live streaming room by performing parallel rendering on the merging special effect data and the foreground special effect data.

In an embodiment, the apparatus further includes a data synchronous pushing module.

The data synchronous pushing module is configured to perform synchronously pushing the merging special effect data and the foreground special effect data to a live browsing object in the target live streaming room.

In an embodiment, the apparatus further includes a foreground special effect data writing module and a data synchronous pushing module.

The foreground special effect data writing module is configured to perform obtaining a target video coding file by writing the foreground special effect data into a live video coding file in response to performing parallel rendering on the merging special effect data and the foreground special effect data: the live video coding file is a video coding file corresponding to the merging special effect data:

the data synchronous pushing module is specifically configured to perform pushing the target video coding file to the live browsing object.

In an embodiment, the real-time live video stream includes a real-time video frame image, and the background special effect data includes real-time background special effect data corresponding to the real-time video frame image: the merging special effect data includes real-time merging special effect data corresponding to the real-time video frame image; and the special effect fusion module 920 includes an object detection unit, a non-object area determining unit and a background replacement processing unit.

The object detection unit is configured to perform determining object contour information of a target object in the real-time video frame image by performing object detection on the real-time video frame image.

The non-object area determining unit is configured to perform determining a non-object area in the real-time video frame image based on the object contour information.

The background replacement processing unit is configured to perform obtaining the real-time merging special effect data by performing background replacement processing on the non-object area in the real-time video frame image based on the real-time background special effect data.

In an embodiment, the foreground special effect data includes real-time foreground special effect data corresponding to the real-time video frame image; and the first parallel rendering module 930 is specifically configured to perform displaying the first live page by performing parallel rendering on the real-time merging special effect data and the real-time foreground special effect data.

In an embodiment, the first data acquiring module 910 includes a special effect rendering task addition unit, a special effect data loading unit and a task start unit.

The special effect rendering task addition unit is configured to perform adding a special effect rendering task of the special effect rendering instruction in a preset rendering queue in response to receiving the special effect rendering instruction.

The special effect data loading unit is configured to perform loading the foreground special effect data and the background special effect data.

The task start unit is configured to perform starting the special effect rendering task and acquiring the real-time live video stream in response to having loaded the foreground special effect data and the background special effect data.

With regard to the apparatus in the above embodiments, the specific way in which each module performs the operation has been described in the embodiments of the method and will not be elaborated here.

FIG. 10 is a block diagram illustrating an apparatus for special effect rendering applicable to a second terminal according to an embodiment. As illustrated in FIG. 10, the apparatus includes a second data acquiring module 1010 and a second parallel rendering module 1020.

The second data acquiring module 1010 is configured to perform acquiring merging special effect data of a target live streaming room and foreground special effect data corresponding to a special effect rendering instruction in response to receiving the special effect rendering instruction for the target live streaming room: the merging special effect data is obtained by performing special effect fusion on a real-time live video stream of the target live streaming room based on background special effect data corresponding to the special effect rendering instruction.

The second parallel rendering module 1020 is configured to perform displaying a second live page corresponding to the target live streaming room by performing parallel rendering on the merging special effect data and the foreground special effect data.

In an embodiment, the second data acquiring module 1010 is specifically configured to perform synchronously pulling the merging special effect data and the foreground special effect data from a server.

In an embodiment, the second data acquiring module 1010 includes a video coding file pulling unit and a coding file parsing unit.

The video coding file pulling unit is configured to perform pulling a target video coding file from the server. The target video coding file is a live video coding file into which the foreground special effect data is written, and the live video coding file is a video coding file corresponding to the merging special effect data.

The coding file parsing unit is configured to perform obtaining the merging special effect data and the foreground special effect data by parsing the target video coding file.

In an embodiment, the real-time live video stream includes a real-time video frame image, and the merging special effect data includes real-time merging special effect data corresponding to the real-time video frame image; and the foreground special effect data includes real-time foreground special effect data corresponding to the real-time video frame image; and

the second parallel rendering module is specifically configured to perform displaying the second live page by performing parallel rendering on the real-time merging special effect data and the real-time foreground special effect data.

With regard to the apparatus in the above embodiments, the specific way in which each module performs the operation has been described in the embodiments of the method and will not be elaborated here.

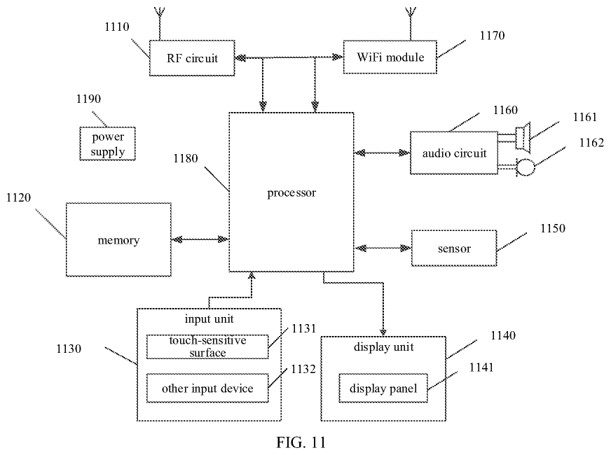

FIG. 11 is a block diagram illustrating an electronic device for special effect rendering according to an embodiment. The electronic device may be a terminal, and an internal structure diagram of the terminal may be illustrated in FIG. 11. The terminal may include a radio frequency (RF) circuit 1110, a memory 1120 including one or more computer-readable storage media, an input unit 1130, a display unit 1140, a sensor 1150, an audio circuit 1160, a wireless fidelity (WiFi) module 1170, a processor 1180 including one or more processing cores, and a power supply 1190. Those skilled in the art will appreciate that the structure of the terminal illustrated in FIG. 11 does not constitute a limitation on the terminal, which may include more or fewer components than illustrated in the figure, or combining certain components, or different component arrangements.

The RF circuit 1110 may be configured to receive and send a signal during a process of receiving and sending information or a call, and specifically, downlink information of the base station is processed by one or more processors 1180 after being received: in addition, related uplink data is sent to the base station. Generally, the RF circuit 1110 includes but not limited to antennas, turners, one or more oscillators, user identity module (SIM) cards, transceivers, couplers, low noise amplifiers (LNA) and duplexers. In addition, the RF circuit 1110 may further communicate with networks and other terminal over wireless communication. The wireless communication may use any communication standard or protocol, including but not limited to a global system of mobile communication (GSM), a general packet radio service (GPRS), a code division multiple access (CDMA), a code division multiple access (CDMA), a wideband code division multiple access (WCDMA), a long term evolution (LTE), a short messaging service (SMS).

The memory 1120 may be configured to store software programs and modules, and the processor 1180 executes various functional applications and data processings by running a software program and a module stored in the memory 1120. The memory 1120 may include a program storage area and a data storage area: the program storage area may store operation systems and application programs required by a function: the data storage area may store data created based on the use of the terminal, etc. In addition, the memory 1120 may include a high-speed random access memory, and may also include a non-volatile memory, such as at least one magnetic disk storage device, a flash memory device, or other non-volatile solid-state storage devices. Correspondingly, the memory 1120 may further include a memory controller to provide access to the memory 1120 by the processor 1180 and the input unit 1130.

The input unit 1130 may receive input digital or character information, and generate keyboard, mouse, joystick, optical or trackball signal inputs related to a user configuration and function control. Specifically, the input unit 1130 may include a touch-sensitive surface 1131 and other input device 1132. The touch-sensitive surface 1131, also referred to as a touch display screen or a touchpad, may collect a touch operation of a user on or near the touch-sensitive surface 1131 (for example, an operation that a user uses any suitable object or accessory such as a finger or a touchpen to touch on the touch-sensitive surface 1131 or near the touch-sensitive surface 1231), and drives a corresponding connection device based on a preset program. In an implementation, the touch-sensitive surface 1131 may include a touch detection device and a touch controller. The touch detection device detects a touch orientation of the user, detects a signal brought by the touch operation, and transmits the signal to a touch controller; and the touch controller receives touch information from the touch detection device, converts the touch information into contact coordinates, and sends the touch information to the processor 1180, and may receive and execute a command sent by the processor 1180. In addition, the touch-sensitive surface 1131 may be implemented in multiple types such as resistive, capacitive, infrared, and surface acoustic waves. In addition to the touch-sensitive surface 1131, the input unit 1130 may further include other input device 1132. Specifically, the other input device 1132 may include, but are not limited to, one or more of a physical keyboard, a function key (such as a volume control button, a switch button), a trackball, a mouse, an operating rod, and the like.

The display unit 1140 is may be configured to display information entered by the user, information provided to the user and various graphic user interfaces of the terminal. The graphic user interfaces may consist of graphics, texts, icons, videos and any combination thereof. The display unit 1140 may include a display panel 1141, and in an implementation, may configure the display panel 1141 in the form of a liquid crystal display (LCD), an organic light-emitting diode (OLED), etc. Further, the touch-sensitive surface 1131 may cover the display panel 1141, and when the touch-sensitive surface 1131 detects a touch operation on or near the touch-sensitive surface 1231, the touch operation is transmitted to the processor 1180 to determine a type of a touch event, and the processor 1180 provides a corresponding visual output on the display panel 1141 based on the type of the touch event. The touch-sensitive surface 1131 may be independent from the display panel 1141 to implement input and input functions, and in some embodiments, the touch-sensitive surface 1131 may also be integrated with the display panel 1141 to implement input and output functions.

The terminal may further include at least one sensor 1150, such as a light sensor, a motion sensor, and other sensors. Specifically, the light sensor may include an ambient light sensor and a proximity sensor. The ambient light sensor may adjust brightness of the display panel 1141 according to brightness of the ambient light, and the proximity sensor may turn off the display panel 1141 and/or backlight when the terminal moves to ears. As one of motion sensors, a gravity acceleration sensor may detect the magnitude of the acceleration in each direction (generally three-axis), the magnitude and direction of gravity when static, to recognize the application of the attitude of the terminal (such as horizontal and vertical screen switching, related game, magnetometer attitude calibration) and vibration recognition related functions (such as a pedometer, knock), etc.; and as for other sensors configurable by the terminal such as a gyroscope, a barometer, a hygrometer, a thermometer, an infrared sensor, which is not repeated here.

An audio circuit 1160, a speaker 1161, and a microphone 1162 may provide an audio interface between the user and the terminal. The audio circuit 1160 may transmit the electrical signal converted by the received audio data to the speaker 1161, and convert from the speaker 1161 to a sound signal for output by the speaker 1261: on the other hand, the microphone 1162 converts the collected sound signal to an electrical signal, receives by the audio circuit 1160 and then converts to the audio data, and processes by an audio data output processor 1180, and sends to another terminal via the RF circuit 1110, or to a memory 1120 for further processing. The audio circuit 1160 may further include an earplug jack to provide communication between a peripheral headset and the terminal.

WiFi belongs to a short-range wireless transmission technology, and the terminal may help the user receive and transmit Email, browse web pages and access streaming media, etc., through the WiFi module 1170, which provides wireless broadband Internet access for the user. Although FIG. 11 illustrates a Wi-Fi module 1170, it is to be understood that it is not a necessary composition of the terminal, and may be omitted entirely as desired without altering the essence of the invention.

The processor 1180, as a control center of the terminal, connects various components of the entire terminal through various interfaces and circuits, and runs or executes software programs and/or modules in the memory 1120 and calls data stored in the memory 1120 to execute various functions and processing data of the terminal, further to entirely monitor the terminal. In an implementation, the processor 1180 may include one or more processing core: preferably, the processor 1180 may integrate an application processor and a modern processor. The application processor mainly deals with an operating system, a user interface and an application program, etc., and the modern processor mainly deals with wireless communication. It is understandable that the above modern may be not integrated in the processor 1180.

The terminal further includes a power source 1190 for powering various components, such as a battery, and preferably the power source may be logically connected to the processor 1180 through the power management system, thereby implementing functions such as charging, discharging, and power consumption management through the power management system. The power supply 1190 may further include one or more DC or AC power supplies, recharging systems, power failure detection circuits, power converters or inverters, power status indicators, and any other components.

The terminal not shown may be further a front camera, a bluetooth module, etc., which is not be repeated here. Specifically in the embodiment, the display unit of the terminal is a touch screen display, and the terminal further includes a memory and one or more programs, one or more of which are stored in the memory and configured to execute instructions in the method embodiments of the disclosure by one or more processors.

In an embodiment, an electronic device is further provided, and includes: a processor: a memory configured to store instructions executable by the processor: the processor is configured to execute the instructions to implement the method for special effect rendering in embodiments of the disclosure.

In an embodiment, a computer-readable storage medium is further provided. When instructions in the storage medium are executed by a processor of an electronic device, the electronic device is caused to perform the method for special effect rendering in embodiments of the disclosure.

In an embodiment, a computer program product including instructions is further provided, and when the computer program is running on a computer, the computer is caused to perform the method for special effect rendering in embodiments of the disclosure.

Those skilled in the art may understand that all or part of flows in the above method embodiments may be implemented by instructing relevant hardwares by a computer program. The computer program may be stored in a non-volatile computer-readable storage medium, and the computer program may include flows of the above method embodiments when being executed. Any reference to a memory, a storage, a database or other media used in embodiments provided in the application may include a non-volatile memory and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration, the RAM may be obtained in various forms, such as a static RAM (SRAM), a dynamic RAM (DRAM), an synchronous DRAM (SDRAM), a dual data rate SDRAM (DDRSDRAM), an enhanced SDRAM (ESDRAM), a synchlink DRAM (SLDRAM), a memory bus (Rambus) direct RAM (RDRAM), a direct memory bus dynamic RAM (DRDRAM), and a memory bus dynamic RAM (RDRAM).

After considering the specification and practicing the disclosure here, those skilled in the art will easily think of other implementations. The present application is intended to cover any variations, usages, or adaptive changes of the present disclosure. These variations, usages, or adaptive changes follow the general principles of the present disclosure and include common knowledge or conventional technical means in the technical field not disclosed by the present disclosure. The description and the embodiments are to be regarded as exemplary only, and the true scope and spirit of the present disclosure are given by the appended claims.

It should be understood that the present disclosure is not limited to the precise structure described above and shown in the drawings, and various modifications and changes may be made without departing from its scope. The scope of the present application is only limited by the appended claims. The scope of the present application is only limited by the appended claims.

What is claimed is:

1. A method for special effect rendering, applied to a first terminal, comprising:
acquiring foreground special effect data corresponding to a special effect rendering instruction, background special effect data corresponding to the special effect rendering instruction and a real-time live video stream of a target live streaming room, in response to receiving the special effect rendering instruction for the target live streaming room;
obtaining merging special effect data by performing special effect fusion on the real-time live video stream based on the background special effect data; and
displaying a first live page corresponding to the target live streaming room by performing parallel rendering on the merging special effect data and the foreground special effect data.

2. The method according to claim 1, further comprising:
synchronously pushing the merging special effect data and the foreground special effect data to a live browsing object in the target live streaming room.

3. The method according to claim 2, further comprising:
obtaining a target video coding file by writing the foreground special effect data into a live video coding file in response to performing parallel rendering on the merging special effect data and the foreground special effect data, wherein the live video coding file is a video coding file corresponding to the merging special effect data; and
synchronously pushing the merging special effect data and the foreground special effect data to the live browsing object in the target live streaming room comprises:
pushing the target video coding file to the live browsing object.

4. The method according to claim 1, wherein the real-time live video stream comprises a real-time video frame image, and the background special effect data comprises real-time background special effect data corresponding to the real-time video frame image: the merging special effect data comprises real-time merging special effect data corresponding to the real-time video frame image; and obtaining the merging special effect data by performing special effect fusion on the real-time live video stream based on the background special effect data comprises:
determining object contour information of a target object in the real-time video frame image by performing object detection on the real-time video frame image;
determining a non-object area in the real-time video frame image based on the object contour information; and
obtaining the real-time merging special effect data by performing background replacement processing on the non-object area in the real-time video frame image based on the real-time background special effect data.

5. The method according to claim 4, wherein the foreground special effect data comprises real-time foreground special effect data corresponding to the real-time video frame image; and displaying the first live page corresponding to the target live streaming room by performing parallel rendering on the merging special effect data and the foreground special effect data comprises:
displaying the first live page by performing parallel rendering on the real-time merging special effect data and the real-time foreground special effect data.

6. The method according to claim 1, wherein acquiring the foreground special effect data corresponding to the special effect rendering instruction, the background special effect data corresponding to the special effect rendering instruction and the real-time live video stream of the target live streaming room in response to receiving the special effect rendering instruction for the target live streaming room, comprises:
adding a special effect rendering task of the special effect rendering instruction in a preset rendering queue in response to receiving the special effect rendering instruction;
loading the foreground special effect data and the background special effect data; and
starting the special effect rendering task and acquiring the real-time live video stream in response to having loaded the foreground special effect data and the background special effect data.

7. A method for special effect rendering, applied to a second terminal, comprising:
acquiring merging special effect data of a target live streaming room and foreground special effect data corresponding to a special effect rendering instruction in response to receiving the special effect rendering instruction for the target live streaming room, wherein the merging special effect data is obtained by performing special effect fusion on a real-time live video stream of the target live streaming room based on background special effect data corresponding to the special effect rendering instruction; and
displaying a second live page corresponding to the target live streaming room by performing parallel rendering on the merging special effect data and the foreground special effect data.

8. The method according to claim 7, wherein acquiring the merging special effect data of the target live streaming room and the foreground special effect data corresponding to the special effect rendering instruction comprises:
synchronously pulling the merging special effect data and the foreground special effect data from a server.

9. The method according to claim 8, wherein synchronously pulling the merging special effect data and the foreground special effect data from the server comprises:
pulling a target video coding file from the server, wherein the target video coding file is a live video coding file into which the foreground special effect data is written, and the live video coding file is a video coding file corresponding to the merging special effect data; and
obtaining the merging special effect data and the foreground special effect data by parsing the target video coding file.

10. The method according to claim 7, wherein the real-time live video stream comprises a real-time video frame image, the merging special effect data comprises real-time merging special effect data corresponding to the real-time video frame image, and the foreground special effect data comprises real-time foreground special effect data corresponding to the real-time video frame image; and
displaying the second live page corresponding to the target live streaming room by performing parallel rendering on the merging special effect data and the foreground special effect data comprises:
displaying the second live page by performing parallel rendering on the real-time merging special effect data and the real-time foreground special effect data.

11. An electronic device, comprising:
a processor; and
a memory configured to store instructions executable by the processor;
wherein the processor is configured to:
acquire foreground special effect data corresponding to a special effect rendering instruction, background special effect data corresponding to the special effect rendering instruction and a real-time live video stream of a target live streaming room, in response to receiving the special effect rendering instruction for the target live streaming room;
obtain merging special effect data by performing special effect fusion on the real-time live video stream based on the background special effect data; and
display a first live page corresponding to the target live streaming room by performing parallel rendering on the merging special effect data and the foreground special effect data.

12. The device according to claim 11, wherein the processor is further configured to:
synchronously push the merging special effect data and the foreground special effect data to a live browsing object in the target live streaming room.

13. The device according to claim 12, wherein the processor is further configured to:
obtain a target video coding file by writing the foreground special effect data into a live video coding file in response to performing parallel rendering on the merging special effect data and the foreground special effect data, wherein the live video coding file is a video coding file corresponding to the merging special effect data; and
the processor, when synchronously pushing the merging special effect data and the foreground special effect data to the live browsing object in the target live streaming room, is further configured to:
push the target video coding file to the live browsing object.

14. The device according to claim 11, wherein the real-time live video stream comprises a real-time video frame image, and the background special effect data comprises real-time background special effect data corresponding to the real-time video frame image: the merging special effect data comprises real-time merging special effect data corresponding to the real-time video frame image; and
the processor, when obtaining the merging special effect data by performing special effect fusion on the real-time live video stream based on the background special effect data, is further configured to:
determine object contour information of a target object in the real-time video frame image by performing object detection on the real-time video frame image:
determine a non-object area in the real-time video frame image based on the object contour information; and
obtain the real-time merging special effect data by performing background replacement processing on the non-object area in the real-time video frame image based on the real-time background special effect data.

15. The device according to claim 14, wherein the foreground special effect data comprises real-time foreground special effect data corresponding to the real-time video frame image; and
the processor, when displaying the first live page corresponding to the target live streaming room by performing parallel rendering on the merging special effect data and the foreground special effect data, is further configured to:
display the first live page by performing parallel rendering on the real-time merging special effect data and the real-time foreground special effect data.

16. The device according to claim 11, wherein the processor is further configured to:
add a special effect rendering task of the special effect rendering instruction in a preset rendering queue in response to receiving the special effect rendering instruction;
load the foreground special effect data and the background special effect data; and
start the special effect rendering task and acquire the real-time live video stream in response to having loaded the foreground special effect data and the background special effect data.
